(19) United States
(12) Patent Application Publication
(10) Pub. No.: US 2008/0014981 A1
(43) Pub. Date: Jan. 17, 2008

(54) Methods and apparatus for providing idle mode operations for a platform with a plurality of wireless communication devices

(76) Inventor: Muthaiah Venkatachalam, Beaverton, OR (US)

Correspondence Address: SCHWABE, WILLIAMSON & WYATT, P.C., PACWEST CENTER, SUITE 1900, 1211 S.W. FIFTH AVE., PORTLAND, OR, 97204, US

(21) Appl. No.: 11/488,805

(22) Filed: Jul. 17, 2006

(51) Int. Cl. H04Q 7/20; H04B 7/00

(52) U.S. Cl. 455/528

(57) ABSTRACT

Embodiments of methods and apparatus for providing idle mode operations for a platform with a plurality of wireless communication devices are generally described herein. Other embodiments may be described and claimed.

### TECHNICAL FIELD

The present disclosure relates generally to wireless communication systems, and more particularly, to methods and apparatus for providing idle mode operations for a platform with a plurality of wireless communication devices.

### BACKGROUND

As wireless communication becomes more and more popular at offices, homes, schools, etc., different wireless technologies and applications may work in tandem to meet the demand for computing and communications at anytime and/or anywhere. For example, a variety and/or plurality of wireless communication networks may coexist to provide a wireless environment with more computing and/or communication capability, greater mobility, and/or eventually seamless roaming.

In particular, wireless personal area networks (WPANs) may offer fast, short-distance connectivity within a relatively small space such as an office workspace or a room within a home. Wireless local area networks (WLANs) may provide broader range than WPANs within office buildings, homes, schools, etc. Wireless metropolitan area networks (WMANs) may cover a greater distance than WLANs by connecting, for example, buildings to one another over a broader geographic area Wireless wide area networks (WWANs) may provide the broadest range as such networks are widely deployed in cellular infrastructure. Although each of the above-mentioned wireless communication networks may support different usages, coexistence among these networks may provide a more robust environment with anytime and anywhere connectivity.

### BRIEF DESCRIPTION OF THE DRAWINGS

FIG. 1 is a schematic diagram representation of an example wireless communication system according to an embodiment of the methods and apparatus disclosed herein.

FIG. 2 is a block diagram representation of an example platform with multiple wireless communication devices.

FIG. 3 depicts an example procedure for an idle mode entry process.

FIG. 4 depicts one manner in which the example platform of FIG. 2 may be configured to execute an idle mode entry process.

FIG. 5 depicts one manner in which an example paging controller may be configured to execute an idle mode entry process.

FIG. 6 depicts an example procedure for performing an idle mode exit process.

FIG. 7 depicts one manner in which the example platform of FIG. 2 may be configured to execute an idle mode exit process.

FIG. 8 depicts one manner in which an example paging controller may be configured to execute an idle mode exit process.

FIG. 9 is a block diagram representation of an example processor system that may be used to implement an example wireless communication platform of the example subscriber station of FIG. 2.

### DETAILED DESCRIPTION

In general, methods and apparatus for providing idle mode operations for a platform with a plurality of wireless communication devices are described herein. The methods and apparatus described herein are not limited in this regard.

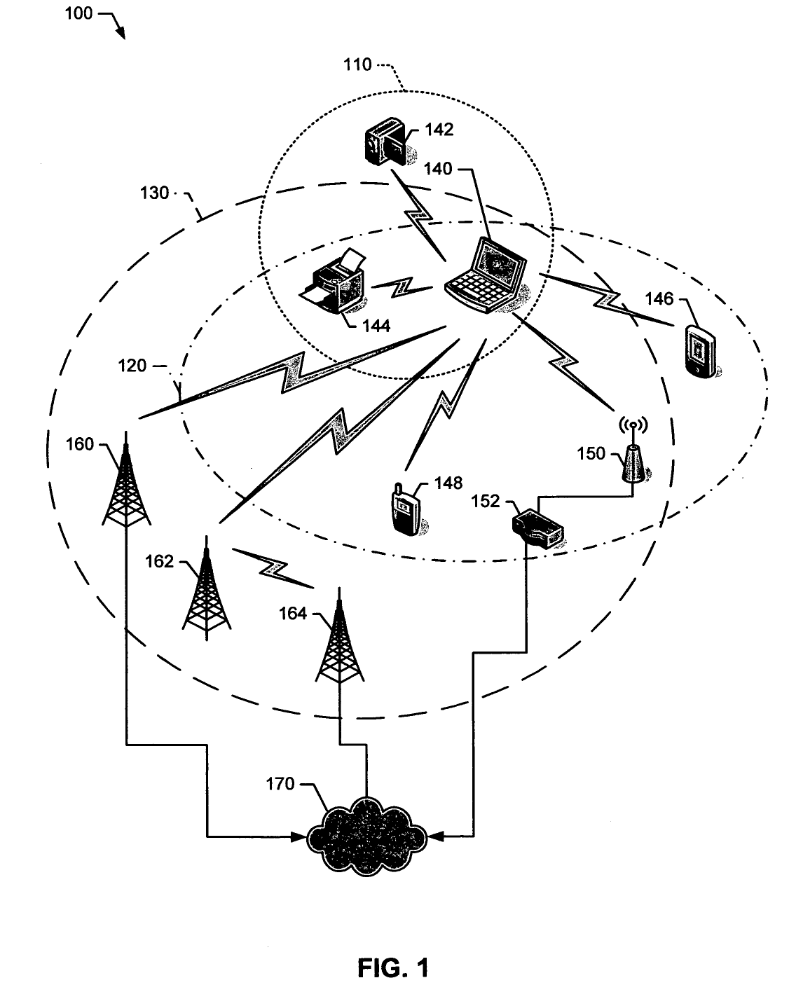

Referring to FIG. 1, an example wireless communication system 100 may include one or more wireless communication networks, generally shown as 110, 120, and 130. In particular, the wireless communication system 100 may include a wireless personal area network (WPAN) 110, a wireless local area network (WLAN) 120, and a wireless metropolitan area network (WMAN) 130. Although FIG. 1 depicts three wireless communication networks, the wireless communication system 100 may include additional or fewer wireless communication networks. For example, the wireless communication system 100 may include additional WPANs, WLANs, and/or WMANs. The methods and apparatus described herein are not limited in this regard.

The wireless communication system 100 may also include one or more subscriber stations, generally shown as 140, 142, 144, 146, and 148. For example, the subscriber stations 140, 142, 144, 146, and 148 may include wireless electronic devices such as a desktop computer, a laptop computer, a handheld computer, a tablet computer, a cellular telephone, a pager, an audio and/or video player (e.g., an MP3 player or a DVD player), a gaming device, a video camera, a digital camera, a navigation device (e.g., a GPS device), a wireless peripheral (e.g., a printer, a scanner, a headset, a keyboard, a mouse, etc.), a medical device (e.g., a heart rate monitor, a blood pressure monitor, etc.), and/or other suitable fixed, portable, or mobile electronic devices. Although FIG. 1 depicts five subscriber stations, the wireless communication system 100 may include more or less subscriber stations.

Each of the subscriber stations 140, 142, 144, 146, and 148 may be authorized or allowed to access services provided by one or more of the wireless communication networks 110, 120, and/or 130. The subscriber stations 140, 142, 144, 146, and 148 may use a variety of modulation techniques such as spread spectrum modulation (e.g., direct sequence code division multiple access (DS-CDMA) and/or frequency hopping code division multiple access (FH-CDMA)), time-division multiplexing (TDM) modulation, frequency-division multiplexing (FDM) modulation, orthogonal frequency-division multiplexing (OFDM) modulation (e.g., orthogonal frequency-division multiple access (OFDMA)), multi-carrier modulation (MDM), and/or other suitable modulation techniques to communicate via wireless links. In one example, the laptop computer 140 may operate in accordance with suitable wireless communication protocols that require very low power such as Bluetooth®, ultra-wide band (UWB), and/or radio frequency identification (RFID) to implement the WPAN 110. In particular, the laptop computer 140 may communicate with devices associated with the WPAN 110 such as the video camera 142 and/or the printer 144 via wireless links.

In another example, the laptop computer 140 may use direct sequence spread spectrum (DSSS) modulation and/or frequency hopping spread spectrum (FHSS) modulation to implement the WLAN 120 (e.g., the 802.11 family of standards developed by the Institute of Electrical and Electronic Engineers (IEEE) and/or variations and evolutions of these standards). For example, the laptop computer 140 may communicate with devices associated with the WLAN 120 such as the printer 144, the handheld computer 146 and/or the smart phone 148 via wireless links. The laptop computer 140 may also communicate with an access point (AP) 150 via a wireless link. The AP 150 may be operatively coupled to a router 152 as described in further detail below. Alternatively, the AP 150 and the router 152 may be integrated into a single device (e.g., a wireless router).

The laptop computer 140 may use OFDM modulation to transmit large amounts of digital data by splitting a radio frequency signal into multiple small sub-signals, which in turn, are transmitted simultaneously at different frequencies. In particular, the laptop computer 140 may use OFDM modulation to implement the WMAN 130. For example, the laptop computer 140 may operate in accordance with the 802.16 family of standards developed by IEEE to provide for fixed, portable, and/or mobile broadband wireless access (BWA) networks (e.g., the IEEE std. 802.16-2004 (published Sep. 18, 2004), the IEEE std. 802.16e (published Feb. 28, 2006), the IEEE std. 802.16f (published Dec. 1, 2005), etc.) to communicate with base stations, generally shown as 160, 162, and 164, via wireless link(s).

Although some of the above examples are described above with respect to standards developed by IEEE, the methods and apparatus disclosed herein are readily applicable to many specifications and/or standards developed by other special interest groups and/or standard development organizations (e.g., Wireless Fidelity (Wi-Fi) Alliance, Worldwide Interoperability for Microwave Access (WiMAX) Forum, Infrared Data Association (IrDA), Third Generation Partnership Project (3GPP), etc.). The methods and apparatus described herein are not limited in this regard.

The WLAN 120 and WMAN 130 may be operatively coupled to a common public or private network 170 such as the Internet, a telephone network (e.g., public switched telephone network (PSTN)), a local area network (LAN), a cable network, and/or another wireless network via connection to an Ethernet, a digital subscriber line (DSL), a telephone line, a coaxial cable, and/or any wireless connection, etc. In one example, the WLAN 120 may be operatively coupled to the common public or private network 170 via the AP 150 and/or the router 152. In another example, the WMAN 130 may be operatively coupled to the common public or private network 170 via the base station(s) 160, 162, and/or 164.

The wireless communication system 100 may include other suitable wireless communication networks. For example, the wireless communication system 100 may include a wireless wide area network (WWAN) (not shown). The laptop computer 140 may operate in accordance with other wireless communication protocols to support a WWAN. In particular, these wireless communication protocols may be based on analog, digital, and/or dual-mode communication system technologies such as Global System for Mobile Communications (GSM) technology, Wideband Code Division Multiple Access (WCDMA) technology, General Packet Radio Services (GPRS) technology, Enhanced Data GSM Environment (EDGE) technology, Universal Mobile Telecommunications System (UMTS) technology, 3GPP technology, standards based on these technologies, variations and evolutions of these standards, and/or other suitable wireless communication standards. Although FIG. 1 depicts a WPAN, a WLAN, and a WMAN, the wireless communication system 100 may include other combinations of WPANs, WLANs, WMANs, and/or WWANs. The methods and apparatus described herein are not limited in this regard.

The wireless communication system 100 may include other WPAN, WLAN, WMAN, and/or WWAN devices (not shown) such as network interface devices and peripherals (e.g., network interface cards (NICs)), access points (APs), redistribution points, end points, gateways, bridges, hubs, etc. to implement a cellular telephone system, a satellite system, a personal communication system (PCS), a two-way radio system, a one-way pager system, a two-way pager system, a personal computer (PC) system, a personal data assistant (PDA) system, a personal computing accessory (PCA) system, and/or any other suitable communication system. Although certain examples have been described above, the scope of coverage of this disclosure is not limited thereto.

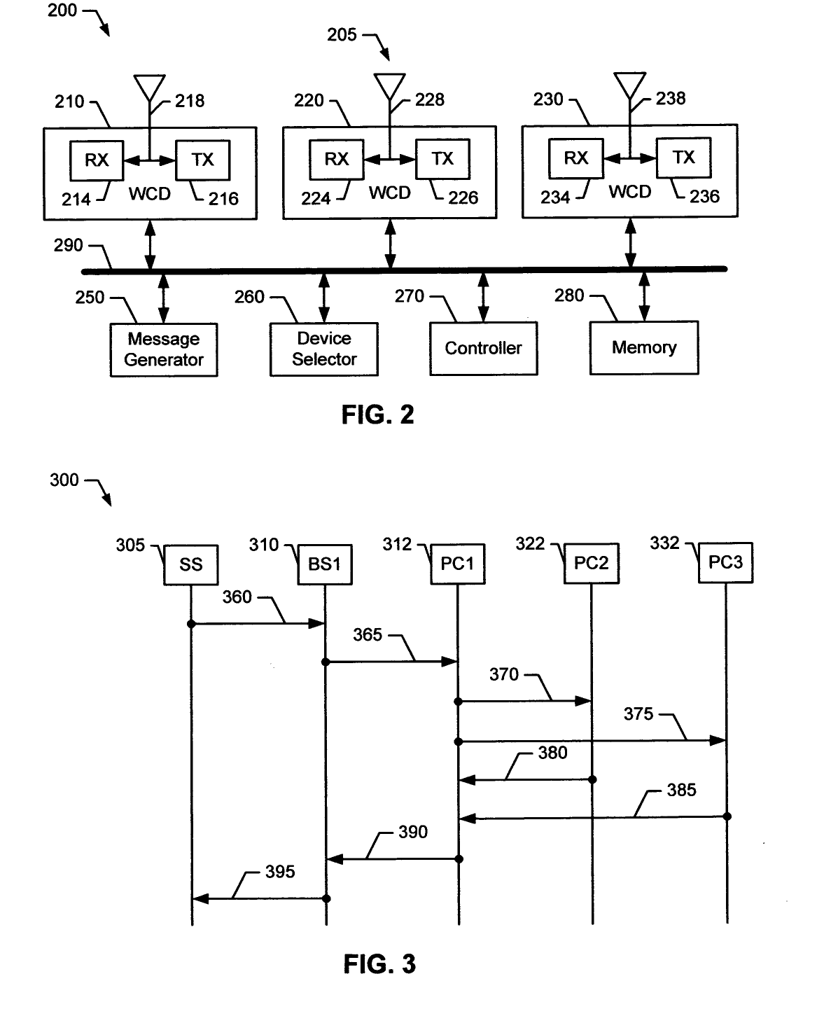

In the example of FIG. 2, a platform 200 may include a plurality of radios or wireless communication devices (WCDs) 205, generally shown as 210, 220, and 230. The platform 200 may be a part of and/or integrated into one of the wireless electronic devices mentioned above in connection with FIG. 1 or any combination thereof. For example, the platform 200 may also include a message generator 250, a device selector 260, a controller 270, and a memory 280. The plurality of wireless communication devices 205, the device selector 250, the message generator 260, the controller 270, and the memory 280 may be operatively coupled to each other via a bus 290. While FIG. 2 depicts components of the platform 200 coupling to each other via the bus 290, these components may be operatively coupled to each other via other suitable direct or indirect connections (e.g., a point-to-point connection or a point-to-multiple point connection). Further, although FIG. 2 depicts three wireless communication devices, the platform 200 may include more or less wireless communication devices.

Each of the plurality of wireless communication devices 205 may include a receiver (RX), generally shown as 214, 224, and 234, and a transmitter (TX), generally shown as 216, 226, and 236. Accordingly, each of the plurality of wireless communication devices 205 may receive and/or transmit data via the receivers 214, 224, and 234 and the transmitters 216, 226, and 236, respectively. Each of the plurality of wireless communication devices 205 may also include an antenna, generally shown as 218, 228, and 238. Each of the antennas 218, 228, and 238 may include one or more directional or omni-directional antennas such as dipole antennas, monopole antennas, patch antennas, loop antennas, microstrip antennas, and/or other types of antennas suitable for transmission of radio frequency (RF) signals. Although FIG. 2 depicts a single antenna associated with each of the plurality of wireless communication devices 205, each of the plurality of wireless communication devices 205 may include additional antennas. For example, each of the plurality of wireless communication devices 205 may include a plurality of antennas to implement a multiple-input-multiple-output (MIMO) system.

Each of the plurality of wireless communication devices 205 may be associated with a wireless communication network such as, for example, a WPAN, a WLAN, a WMAN, a WWAN, or a wireless mesh network. As noted above in connection with FIG. 1, each type of wireless communication network may operate based on a particular wireless communication technology. To illustrate the application of the plurality of wireless communication devices 205 with heterogeneous wireless communication networks, the wireless communication device 210 may operate based on Wi-Fi technology, the wireless communication device 220 may operate based on WiMAX technology, and the wireless communication device 230 may operate based on Third Generation (3G) technology. Each of the plurality of wireless communication devices 205 may be used to perform various applications based on a variety of factors such as quality of service (QoS), cost per bit, coverage area, mobility, etc. In one example, the wireless communication device 210 may be used for transmission control protocol (TCP) and/or web browsing, the wireless communication device 220 may be used for video streaming, and the wireless communication device 230 may be used for voice over Internet protocol (VoIP). Although the plurality of wireless communication devices 205 are described above to operate in a particular manner, the plurality of wireless communication devices 205 may be used to perform various applications.

Briefly, Wi-Fi technology may provide high-speed wireless connectivity within a range of a wireless access point (e.g., a hotspot) in different locations including homes, offices, cafes, hotels, airports, etc. In particular, Wi-Fi technology may allow a wireless device to connect to a local area network without physically plugging the wireless device into the network when the wireless device is within a range of a wireless access point (e.g., within 150 feet indoor or 300 feet outdoors). In one example, Wi-Fi technology may offer high-speed Internet access and/or Voice over Internet Protocol (VoIP) service connection to wireless devices. The 802.11 family of standards was developed by IEEE to provide for WLANs (e.g., the IEEE std. 802.11a published 1999, the IEEE std. 802.11b published 1999, the IEEE std. 802.11g published 2003, variations, and/or evolutions of these standards). The Wi-Fi Alliance facilitates the deployment of WLANs based on the 802.11 standards. In particular, the Wi-Fi Alliance ensures the compatibility and inter-operability of WLAN equipment. For convenience, the terms “802.11” and “Wi-Fi” may be used interchangeably throughout this disclosure to refer to the IEEE 802.11 suite of air interface standards.

WiMAX technology may provide last-mile broadband connectivity in a larger geographical area (e.g., hot zones than other wireless technology such as Wi-Fi technology. In particular, WiMAX technology may provide broadband or high-speed data connection to various geographical locations where wired transmission may be too costly, inconvenient, and/or unavailable. In one example, WiMAX technology may offer greater range and bandwidth to enable T1-type service to businesses and/or cable/digital subscriber line (DSL)-equivalent access to homes. The 802.16 family of standards was developed by IEEE to provide for fixed, portable, and/or mobile broadband wireless access networks (e.g., the IEEE std. 802.16-2004 published 2004, the IEEE std. 802.16e published 2006, the IEEE std. 802.16f published 2005, variations, and/or evolutions of these standards). The WiMAX Forum facilitates the deployment of broadband wireless access networks based on the IEEE 802.16 standards. In particular, the WiMAX Forum ensures the compatibility and inter-operability of broadband wireless equipment. For convenience, the terms “802.16” and “WiMAX” may be used interchangeably throughout this disclosure to refer to the IEEE 802.16 suite of air interface standards.

Third Generation technology may provide broad-range coverage for voice communications, data access, and/or Internet connectivity across wide geographic areas. In particular, 3G technology may provide great mobility for devices whose primary function is voice services with additional data applications as a complement to those services. For example, such devices may include cellular telephones that may also provide interactive video conferencing, or a handheld computers (or PDAs) that may provide full-playback DVD services. To provide such high-speed wireless communication services, the International Mobile Telecommunications (IMT-2000) family of standards was developed by the International Telecommunications Unit (e.g., W-CDMA, CDMA2000, etc.).

Although the above examples are described with respect to particular wireless communication technologies, the plurality of wireless communication devices 205 may operate based on other suitable types of wireless communication technology. For example, one of the plurality of wireless communication devices 205 may operate based on UWB technology instead or the plurality of wireless communication devices 205 may include an additional wireless communication device that may operate based on UWB technology.

To reduce power consumption, bandwidth usage, processing resources, etc., one or more of the plurality of wireless communication devices 205 may operate in idle mode. In particular, each of the plurality of wireless communication devices 205 may be inactive but readily available to operate in active mode if necessary. Each of the plurality of wireless communication devices 205 may monitor for a paging message from a corresponding node (e.g., an access point or a base station) via a paging channel. For example, the paging message may be indicative of an incoming communication such as a voice call, a text message, streaming media, etc. In response to receipt of the paging message, one or more of the plurality of wireless communication devices 205 may receive the incoming communication. In addition or alternatively, an individual may manually select one or more of the plurality of wireless communication devices 205 to operate in active mode instead of idle mode.

Instead of each of the plurality of wireless communication devices 205 performing or executing separate processes to either enter into or exit from idle mode, the platform 200 may coordinate and process a single request for at least one of the plurality of wireless communication devices 205 to either enter into or exit from idle mode as described in detail below. In particular, the message generator 250 may generate an idle mode message. For example, the idle mode message may include information associated with the plurality of wireless communication devices 205 such as identification, idle duration, recent communication, and/or other suitable information of each of the plurality of wireless communication devices 205. The idle mode message may be an idle mode entry request or an idle mode exit request. In particular, the message generator 250 may generate an idle mode entry request to initiate idle mode for at least one wireless communication devices of the plurality of wireless communication devices 205. The message generator 250 may generate an idle mode exit request for at least one wireless communication devices of the plurality of communication devices 205 to exit from idle mode.

The device selector 260 may select one of the plurality of wireless communication devices 205 to operate as a proxy to transmit the idle mode message from the message generator 250. In one example, the device selector 260 may select the wireless communication device that uses the lowest transmit power to transmit the idle mode message(s). In another example, the device selector 260 may also select the wireless communication device that is currently in active mode or the last wireless communication device to transmit. In yet another example, each of the plurality of wireless communication devices 205 may take turn to transmit idle mode message(s) for a predefined time period in a round-robin manner. Alternatively, an individual may designate one of the plurality of wireless communication devices 205 to transmit the idle mode message.

The controller 270 may operate at least one of the plurality of wireless communication devices 205 in idle mode based on paging information of an idle mode entry response. In particular, the paging information may include paging cycle and/or paging offset for at least one of the plurality of communication devices 205. For example, the wireless communication device 220 may be awake for ten milliseconds (ms) every second to monitor for a paging message. The controller 270 may also establish a direct wireless communication link between one of the plurality of wireless communication devices 205 and a corresponding node.

The memory 280 may store the idle mode information and/or the paging information associated with each of the plurality of wireless communication devices 205. For example, the idle mode information may include information provided by the platform 200 such as identification information of each of the plurality of wireless communication devices 205, and which one of the plurality of wireless communication devices 205 was selected to transmit the idle mode message (i.e., proxy device). The idle mode information may also include a length of time that each of the plurality of wireless communication devices 205 may have been operating in idle mode (i.e., idle duration). The paging information may include information from at least one paging controller (e.g., the paging controllers 312, 322, and/or 332 of FIG. 3) for at least one of the plurality of wireless communication devices 205 to operate in idle mode. As noted above, for example, the paging information may include information associated with paging cycle, paging offset, and/or other suitable information.

Although the components shown in FIG. 2 are depicted as separate blocks within the platform 200, the functions performed by some of these blocks may be integrated within a single semiconductor circuit or may be implemented using two or more separate integrated circuits. In one example, although the receiver 214 and the transmitter 216 are depicted as separate blocks within the wireless communication device 210, the receiver 214 may be integrated into the transmitter 216 (e.g., a transceiver). In another example, the message generator 250, device selector 260, and/or the controller 270 may integrated into a single component (e.g., a processor). The methods and apparatus described herein are not limited in this regard.

In the example of FIG. 3, an idle mode control system 300 may include a subscriber station (SS) 305 (e.g., the laptop computer 140 of FIG. 1) and one or more base stations (BS1), generally shown as 310. Although the methods and apparatus described herein are readily applicable to various standards and/or technologies developed by different special interest groups (SIGs) and/or standards development organizations (SDOs), the idle mode control system 300 may operate in accordance with, for example, the 802.21 family of standards, and/or variations and evolutions of these standards currently being developed by IEEE. The subscriber station 305 may include a platform with a plurality of wireless communication devices (e.g., the platform 200 of FIG. 2). The subscriber station 305 and the base station 310 may be communicatively coupled to each other via a wireless communication link. The subscriber station 305 may be powered on a wireless network for significant time durations, but may not be in active mode (e.g., a call session). During times when the subscriber station 305 is not active mode such as battery conserving opportunities, idle mode and paging operations may be defined in various wireless communication standards and/or variations and evolutions of these standards developed by different SIGs and/or SDOs (e.g., IEEE, Wi-Fi Alliance, WiMAX Forum, 3GPP, etc.).

The idle mode control system 300 may also include two or more paging controllers (PC1, PC2, and PC3), generally shown as 312, 322, and 332, respectively. Each of a plurality of wireless communication devices of the subscriber station 305 may correspond to one of paging controllers 312, 322, and 332. That is, each of the paging controllers 312, 322, and 332 may be communicatively coupled to a node (e.g., an access point, a base station, etc.) configured to communicate with one of the plurality of wireless communication devices of the subscriber station 305.

Referring to both FIGS. 2 and 3, for example, the wireless communication device 210 may be associated with the paging controller 312, the wireless communication device 220 may be associated with the paging controller 322, and the wireless communication device 230 may be associated with the paging controller 332 as described in detail below. At least one of the plurality of wireless communication devices 205 of the subscriber station 305 may enter into idle mode to conserve power, bandwidth, and/or processing resources. To operate in idle mode, the wireless communication device 210 may submit a request to the paging controller 312, which in turn, may either grant or deny the request to enter into idle mode. In a similar manner, the wireless communication device 220 may submit a request to paging controller 322, and the wireless communication device 230 may submit a request to the paging controller 332.

Instead of performing separate idle mode entry processes for each of the plurality of wireless communication devices 205 (e.g., transmitting separate requests to operate in idle mode to the paging controllers 312, 322, and/or 332), however, the subscriber station 305 may generate a single idle mode entry request. In particular, the idle mode entry request may include idle mode information for at least one of the plurality of wireless communication devices 205 requesting to operate in idle mode. Accordingly, the subscriber station 305 may transmit the idle mode entry request to the base station 310 (360).

In turn, the base station 310 may forward the idle mode entry request to the paging controller 312 (365). As noted above, the paging controller 312 may be communicatively coupled to the base station 310. The paging controller 312 may forward the idle mode information associated with each of the plurality of wireless communication devices 205 to the corresponding paging controller. In one example, the paging controller 312 may forward the idle mode information associated with the wireless communication device 220 to the paging controller 332 (370). In another example, the paging controller 312 may forward the idle mode information associated with the wireless communication device 230 to the paging controller 342 (375).

Each of the paging controllers 312, 322, and/or 332 may provide paging information to the paging controller 312 for the wireless communication devices 210, 220, and 230, respectively, to operate in idle mode (380 and 385). As noted above, for example, the paging information may include paging cycle, paging offset, and/or other paging parameters based on the wireless communication technology to locate the subscriber station 305 in idle mode. The paging controller 312 may generate and provide an idle mode entry response to the base station 310 (390). In particular, the idle mode entry response may include the paging information for each of the plurality of wireless communication devices 205 to operate in idle mode. Accordingly, the base station 310 may transmit the idle mode entry response to the subscriber station 305 (395). Based on the paging information, the plurality of wireless communication devices 205 may operate in idle mode.

Although the above examples are described with respect to base stations, the methods and apparatus described herein are readily applicable to other suitable type of nodes associated with wireless communication networks (e.g., access points, subscriber stations, etc.). For example, the subscriber station 305 may transmit the idle mode entry request and/or receive the idle mode entry response from an access point. The methods and apparatus described herein are not limited in this regard.

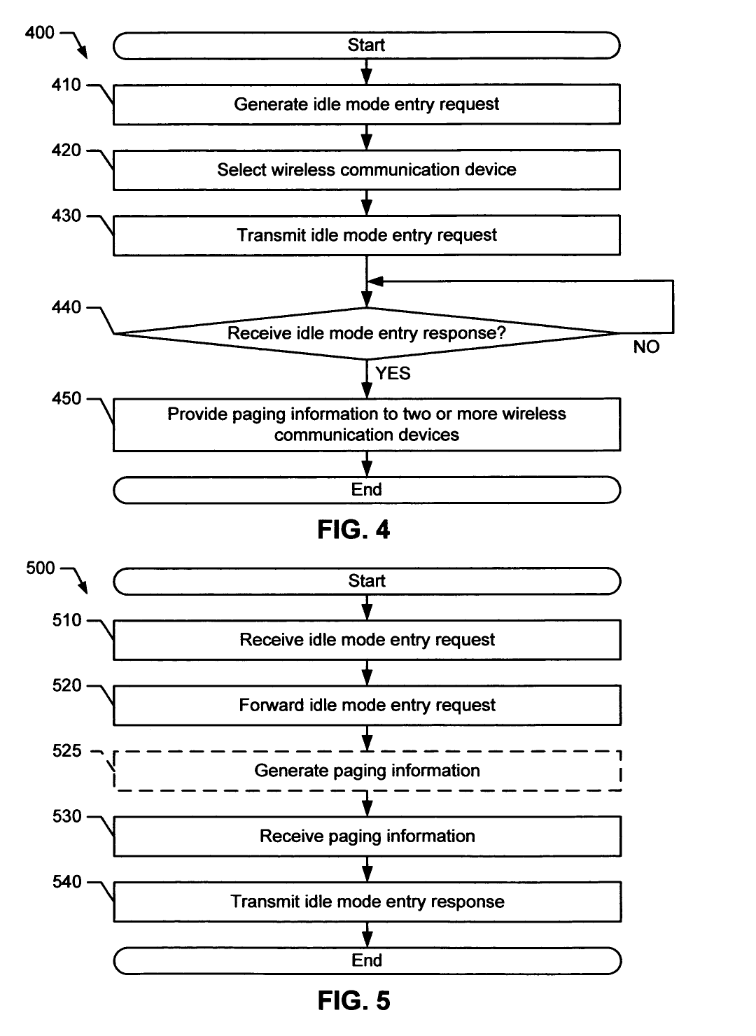

FIGS. 4 and 5 depict one manner in which the idle mode control system 300 of FIG. 3 may be configured. The example processes 400 and 500 of FIGS. 4 and 5, respectively, may be implemented as machine-accessible instructions utilizing any of many different programming codes stored on any combination of machine-accessible media such as a volatile or non-volatile memory or other mass storage device (e.g., a floppy disk, a CD, and a DVD). For example, the machine-accessible instructions may be embodied in a machine-accessible medium such as a programmable gate array, an application specific integrated circuit (ASIC), an erasable programmable read only memory (EPROM), a read only memory (ROM), a random access memory (RAM), a flash memory, a magnetic media, an optical media, and/or any other suitable type of medium.

Further, although a particular order of actions is illustrated in each of FIGS. 4 and 5, these actions may be performed in other temporal sequences (e.g., simultaneously or concurrently). Again, the example processes 400 and 500 are merely provided and described in conjunction with the platform 200 of FIG. 2 as an example of one way to provide an idle mode control system.

In the example of FIG. 4, the process 400 may begin with the subscriber station 305 (e.g., via the message generator 250 of FIG. 2) generating an idle mode entry request so that at least one of the plurality of wireless communication devices 205 may enter into idle mode (block 410). In one example, the wireless communication devices 210 and 220 may request to enter into idle mode. In another example, the wireless communication devices 220 and 230 may request to enter into idle mode. In yet another example, the wireless communication devices 210 and 230 may request to enter into idle mode. Alternatively, all of the plurality of wireless communication devices 205 may request to enter into idle mode.

The subscriber station 305 (e.g., via the device selector 260 of FIG. 2) may select one of the plurality of wireless communication devices 205 to serve as a proxy device for the plurality of wireless communication devices 205 to transmit the idle mode message (block 420). Accordingly, the proxy device may transmit the idle mode entry request to a node associated with the proxy device (block 430). In one example, the subscriber station 305 may select the wireless communication device 210 as the proxy device and transmit the idle mode message to the base station 310 via the wireless communication device 210.

Upon receipt of the idle mode message from the proxy device of the plurality of wireless communication devices 205, the node may forward the idle mode message to a paging controller associated with the node. In one example, the base station 310 may forward the idle mode message from the subscriber station 305 to the paging controller 312 because the base station 310 and the paging controller 312 are associated with the same wireless communication network.

Turning to FIG. 5, for example, the process 500 may begin with the paging controller 312 receiving the idle mode entry request from the base station 310 (block 510). The paging controller 312 may forward the idle mode entry request to other paging controllers, which are associated with the other devices of the plurality of wireless communication devices 205 that requested to enter into idle mode (block 520). In one example, the paging controller 312 may forward the idle mode entry request to the paging controllers 322 and 332. In turn, the paging controllers 322 and 332 may generate paging information for the wireless communication devices 220 and 230, respectively. In a similar manner, the paging controller 312 may generate paging information for the wireless communication device 210 if the wireless communication device 210 requests to enter into idle mode (block 525).

The paging controller 312 may receive paging information for each of the plurality of wireless communication devices 205 requesting to enter into idle mode from the corresponding paging controllers (block 530). In one example, the paging controller 312 may receive paging information from the paging controllers 322 and/or 332 for the wireless communication devices 220 and/or 230, respectively, to enter into idle mode. Accordingly, the paging controller 312 may generate and transmit an idle mode entry response to the base station 310 (block 540). In particular, the idle mode entry response may include paging information for at least one of the plurality of wireless communication devices 205 to enter into idle mode. In turn, the base station 310 may forward the idle mode entry response to the subscriber station 305 so that at least one of the plurality of wireless communication devices 205 may operate in idle mode. The methods and apparatus described herein are not limited in this regard.

Referring back to FIG. 4, the subscriber station 305 may monitor for an idle mode entry response from the node (block 440). If the subscriber station 305 does not receive an idle mode entry response, the subscriber station 305 may continue to monitor for an idle mode entry response. Otherwise if the subscriber station 305 receives an idle mode entry response, the subscriber station 305 may provide the paging information in the idle mode entry response to at least one of the plurality of wireless communication devices 205 (block 450). The methods and apparatus described herein are not limited in this regard.

At least one of the plurality of wireless communication devices 205 (e.g., the wireless communication devices 210 and 220 of FIG. 2) may request to exit from idle mode for various reasons such as to initiate and/or receive data, voice, and/or video sessions. Instead of each of the plurality of wireless communication devices 205 separately requesting to exit from idle mode, the subscriber station 305 may generate an idle mode exit request including information associated with at least one of the plurality of wireless communication devices 205 requesting to exit from idle mode.

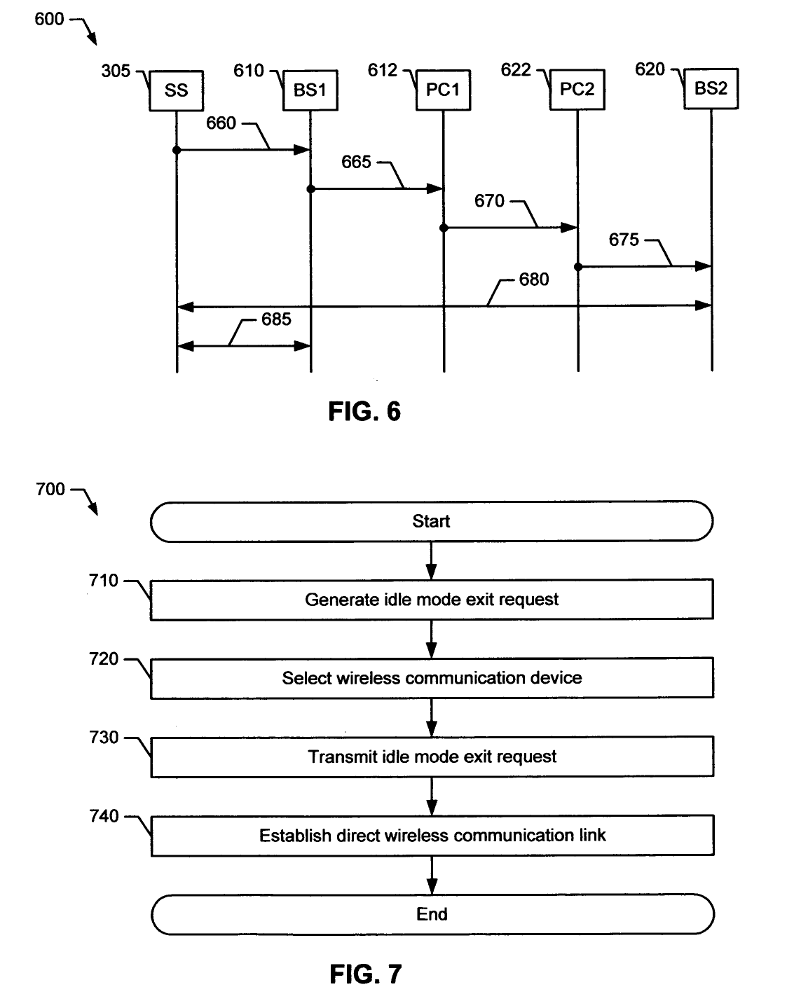

In the example of FIG. 6, the idle mode control system 600 may include a first base station (BS1) 610, a second base station (BS2) 620, a first paging controller (PC1) 612, and a second paging controller (PC2) 622. Although FIG. 6 depicts two base stations and two paging controllers, the idle mode control system 600 may include additional base stations and/or paging controllers. The first base station 610 and the first paging controller 612 may be associated with a first wireless communication network whereas the second base station 620 and the second paging controller 622 may associated with a second wireless communication network. As noted above, the platform 200 (FIG. 2) with the plurality of wireless communication devices 205 may be integrated into the subscriber station 305. In one example, a first wireless communication device (e.g., the wireless communication device 210 of FIG. 2) may be associated with the first communication network, and a second wireless communication device (e.g., the wireless communication device 220 of FIG. 2) may be associated with the second wireless network.

To illustrate an example process to exit from idle mode for one or more of the plurality of wireless communication devices 205, the subscriber station 305 may generate an idle mode exit request and select one of the plurality of wireless communication devices 205 to transmit the idle mode exit request. In one example, the subscriber station 305 may select the first wireless communication device 210 to transmit the idle mode exit request. Accordingly, the subscriber station 305 (e.g., via the first wireless communication device 210) may transmit the idle mode exit request to the first base station 610 so that one or more of the plurality of wireless communication devices 205 may establish a direct wireless communication link with a corresponding base station (e.g., shown below as 680 and/or 685) (660). In turn, the first base station 610 may forward the idle mode exit request to the first paging controller 612 (665).

In response to receipt of the idle mode exit request, the first paging controller 612 may also forward the idle mode exit request to one or more paging controllers. In one example, the first paging controller 612 may forward the idle mode exit request to the second paging controller 622 because the second wireless communication device 220 is request to exit from idle mode (670). In turn, the second paging controller 622 may forward the idle mode request to the second base station 620 (675). Accordingly, the second base station 620 and the second wireless communication device 220 of the subscriber station 305 may establish a direct wireless communication link for the second wireless communication device 220 to operate in active mode (680). In a similar manner, the first base station 610 and the first wireless communication device 210 may establish a direct wireless communication link for the first wireless communication device 210 to operate in active mode (685). The direct wireless links (e.g., 680 and 685) may be established simultaneously, concurrently, or sequentially. In one example, the direct wireless communication link between the second wireless communication device 220 and the base station 620 may be established using the direct wireless communication link between the first wireless communication device 210 and the first base station 610 was previously established. That is, the second wireless communication device 220 may exit from idle mode by sending the idle mode exit request through the first wireless communication device 210 that is operating in active mode. The methods and apparatus described herein are not limited in this regard.

Turning to FIG. 7, the process 700 may begin with the subscriber station 305 (e.g., via the message generator 250 of FIG. 2) generating an idle mode exit request for at least one of the plurality of wireless communication devices 205 (block 710). In one example, the subscriber station 305 may generate the idle mode exit request for the wireless communication devices 210 and 220. The idle mode exit request may include idle mode information such as identification and idle mode duration of the wireless communication devices 210 and 220. The subscriber station 305 (e.g., via the device selector 260 of FIG. 2) may select one of the plurality of wireless communication devices 205 to transmit the idle mode exit request (block 720). In one example, the subscriber station 305 (e.g., via the device selector 260 of FIG. 2) may select the wireless communication device 210 to transmit the idle mode exit request. Accordingly, the subscriber station 305 may transmit the idle mode exit request to a base station associated with the same wireless communication network as the selected wireless communication device (block 730). Following the above example, the subscriber station 305 may transmit the idle mode exit request to the base station 310 because the subscriber station 305 selected to use the wireless communication device 210 to transmit the idle mode exit request. In another example, the subscriber station 305 may transmit the idle mode exit request to the base station 320 if the subscriber station 305 selected to use the wireless communication device 220 to transmit the idle mode exit request.

The subscriber station 305 (e.g., via the controller 270 of FIG. 2) may establish a direct wireless communication link between each of the plurality of wireless communication devices 205 that requested to exit from idle mode and a corresponding node (block 740). In one example, the subscriber station 305 may establish a direct wireless communication link between the wireless communication device 220 and the base station 620.

While a particular order of actions is illustrated in FIG. 7, these actions may be performed in other temporal sequences (e.g., simultaneously or concurrently). Although the above examples are described with a subscriber station initiating an idle mode entry process (e.g., the process 400 of FIG. 4) and/or an idle mode exit process (e.g., the process 700 of FIG. 7) for at least one of a plurality of wireless communication devices associated with a platform that is integrated into the subscriber station, the methods and apparatus described herein may be implemented a base station and/or a paging controller to initiate the idle mode entry process and/or the idle mode exit process. In addition, the methods and apparatus described herein are readily applicable to other suitable type of nodes associated with wireless communication networks (e.g., access points, subscriber stations, etc.) even though the above examples are described with respect to base stations. The methods and apparatus described herein are not limited in this regard.

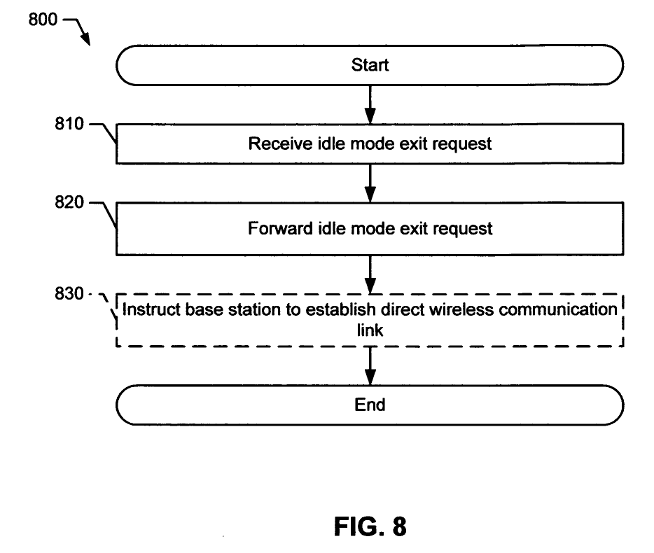

In the example of FIG. 8, the process 800 may begin with the paging controller 612 receiving the idle mode exit request from the base station 610 (block 810). The paging controller 612 may forward the idle mode exit request to other paging controllers, which are associated with the other devices of the plurality of wireless communication devices 205 that requested to exit from idle mode (block 820). In one example, the paging controller 612 may forward the idle mode exit request to the paging controller 622. In turn, the paging controller 622 may instruct the base station 620 to establish a direct wireless communication link with the subscriber station 305. Accordingly, the base station 620 may establish a direct wireless communication link with the wireless communication device 220 (e.g., 680 of FIG. 6). In a similar manner, the paging controller 612 may instruct the base station 610 to establish a direct wireless communication link with the subscriber station 305 if the wireless communication device 210 requested to exit from idle mode (block 830). The base station 610 may establish a direct wireless communication link with the first wireless communication device 210 (e.g., 685 of FIG. 6). The methods and apparatus described herein are not limited in this regard.

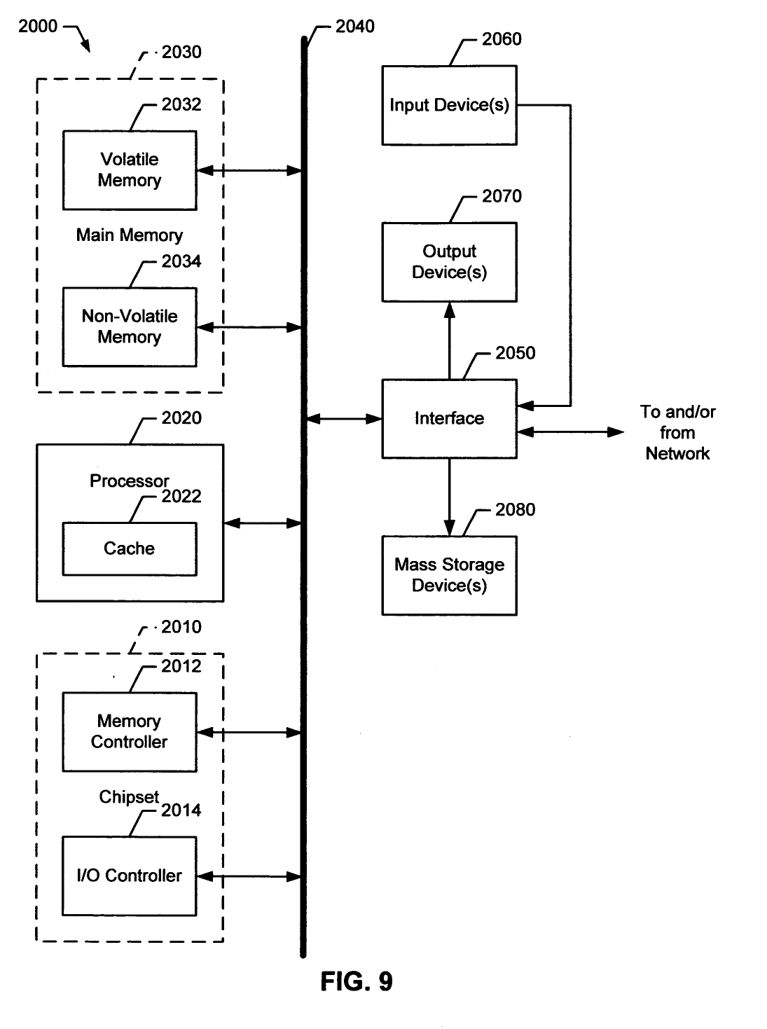

FIG. 9 is a block diagram of an example processor system 2000 adapted to implement the methods and apparatus disclosed herein. The processor system 2000 may be a desktop computer, a laptop computer, a handheld computer, a tablet computer, a personal digital assistant (PDA), a server, an Internet appliance, and/or any other type of computing device.

The processor system 2000 illustrated in FIG. 9 may include a chipset 2010, which includes a memory controller 2012 and an input/output (I/O) controller 2014. The chipset 2010 may provide memory and I/O management functions as well as a plurality of general purpose and/or special purpose registers, timers, etc. that are accessible or used by a processor 2020. The processor 2020 may be implemented using one or more processors, WPAN components, WLAN components, WMAN components, WWAN components, and/or other suitable processing components. For example, the processor 2020 may be implemented using one or more of the Intel® Core™ technology, the Intel® Pentium® technology, the Intel® Itanium® technology, the Intel® Centrino™ technology, and/or the Intel® Xeon™ technology. In the alternative, other processing technology may be used to implement the processor 2020. The processor 2020 may include a cache 2022, which may be implemented using a first-level unified cache (L1), a second-level unified cache (L2), a third-level unified cache (L3), and/or any other suitable structures to store data.

The memory controller 2012 may perform functions that enable the processor 2020 to access and communicate with a main memory 2030 including a volatile memory 2032 and a non-volatile memory 2034 via a bus 2040. The volatile memory 2032 may be implemented by synchronous dynamic random access memory (SDRAM), dynamic random access memory (DRAM), RAMBUS dynamic random access memory (RDRAM), static random access memory (SRAM) and/or any other type of random access memory device. The non-volatile memory 2034 may be implemented by flash memory, read only memory (ROM), electrically erasable programmable read only memory (EEPROM), and/or any other desired type of memory device.

The processor system 2000 may also include an interface circuit 2050 that is coupled to the bus 2040. The interface circuit 2050 may be implemented using any type of interface standard such as an Ethernet interface, a universal serial bus (USB), a third generation input/output (3GIO) interface, and/or any other suitable type of interface.

One or more input devices 2060 may be connected to the interface circuit 2050. The input device(s) 2060 permit an individual to enter data and commands into the processor 2020. For example, the input device(s) 2060 may be implemented by a keyboard, a mouse, a touch-sensitive display, a track pad, a track ball, an isopoint, and/or a voice recognition system.

One or more output devices 2070 may also be connected to the interface circuit 2050. For example, the output device(s) 2070 may be implemented by display devices (e.g., a light emitting display (LED), a liquid crystal display (LCD), a cathode ray tube (CRT) display, a printer and/or speakers). The interface circuit 2050 may include, among other things, a graphics driver card.

The processor system 2000 may also include one or more mass storage devices 2080 to store software and data. Examples of such mass storage device(s) 2080 include floppy disks and drives, hard disk drives, compact disks and drives, and digital versatile disks (DVD) and drives.

The interface circuit 2050 may also include a communication device such as a modem or a network interface card to facilitate exchange of data with external computers via a network. The communication link between the processor system 2000 and the network may be any type of network connection such as an Ethernet connection, a digital subscriber line (DSL), a telephone line, a cellular telephone system, a coaxial cable, etc.

Access to the input device(s) 2060, the output device(s) 2070, the mass storage device(s) 2080 and/or the network may be controlled by the I/O controller 2014. In particular, the I/O controller 2014 may perform functions that enable the processor 2020 to communicate with the input device(s) 2060, the output device(s) 2070, the mass storage device(s) 2080 and/or the network via the bus 2040 and the interface circuit 2050.

While the components shown in FIG. 9 are depicted as separate blocks within the processor system 2000, the functions performed by some of these blocks may be integrated within a single semiconductor circuit or may be implemented using two or more separate integrated circuits. For example, although the memory controller 2012 and the I/O controller 2014 are depicted as separate blocks within the chipset 2010, the memory controller 2012 and the I/O controller 2014 may be integrated within a single semiconductor circuit.

Although certain example methods, apparatus, and articles of manufacture have been described herein, the scope of coverage of this disclosure is not limited thereto. On the contrary, this disclosure covers all methods, apparatus, and articles of manufacture fairly falling within the scope of the appended claims either literally or under the doctrine of equivalents. For example, although the above discloses example systems including, among other components, software or firmware executed on hardware, it should be noted that such systems are merely illustrative and should not be considered as limiting. In particular, it is contemplated that any or all of the disclosed hardware, software, and/or firmware components could be embodied exclusively in hardware, exclusively in software, exclusively in firmware or in some combination of hardware, software, and/or firmware.

What is claimed is:

1. A method comprising:
generating an idle mode message having idle mode information associated with a plurality of wireless communication devices coexisting and located within a single platform at a subscriber station, the plurality of wireless communication devices having at least a first wireless communication device associated with a first wireless communication network and a second wireless communication device associated with a second wireless communication network; and
selecting the first wireless communication device to transmit the idle mode message to a first paging controller of the first wireless communication network via a node of the first wireless communication network, the first paging controller being operatively coupled to the node of the first wireless communication network and configured to forward the idle mode message to a second paging controller of the second wireless communication network.

2. A method as defined in claim 1, wherein generating the idle mode message comprises generating at least one of an idle mode entry request or an idle mode exit request.

3. A method as defined in claim 1 further comprising transmitting the idle mode message to at least one of an access point of a wireless local area network, a base station of a wireless metropolitan area network, or a base station of a wireless wide area network.

4. A method as defined in claim 1 further comprising receiving an idle mode entry response having paging information for one or more of the plurality of wireless communication devices to enter into idle mode, the paging information having information associated with at least one of paging cycle or paging offset.

5. A method as defined in claim 1 further comprising operating one or more of the plurality of wireless communication devices in idle mode in response to receipt of an idle mode entry response from the node of the first wireless communication network.

6. A method as defined in claim 1 further comprising exiting one or more of the plurality of wireless communication devices from idle mode in response to transmitting an idle mode exit request.

7. A method as defined in claim 1 further comprising establishing a wireless communication link between the second wireless communication device and a node of the second wireless communication network in response to transmitting an idle mode exit request.

8. An apparatus comprising:
a message generator to generate an idle mode message having idle mode information associated with a plurality of wireless communication devices coexisting and located within a single platform at a subscriber station, the plurality of wireless communication devices having at least a first wireless communication device associated with a first wireless communication network and a second wireless communication device associated with a second wireless communication network; and
a device selector operatively coupled to the message generator to select the first wireless communication device to transmit the idle mode message to a first paging controller of the first wireless communication network via a node of the first wireless communication network, the first paging controller being operatively coupled to the node of the first wireless communication network and configured to forward the idle mode message to a second paging controller of the second wireless communication network.

9. An apparatus as defined in claim 8, wherein the idle mode message comprises at least one of an idle mode entry request or an idle mode exit request.

10. An apparatus as defined in claim 8 further comprising a network interface device to transmit the idle mode message to at least one of an access point of a wireless local area network, a base station of a wireless metropolitan area network, or a base station of a wireless wide area network.

11. An apparatus as defined in claim 8 further comprising a network interface device to receive an idle mode entry response having paging information for one or more of the plurality of wireless communication devices to enter into idle mode, the paging information having information associated with at least one of paging cycle or paging offset.

12. An apparatus as defined in claim 8 further comprising a controller to operate one or more of the plurality of wireless communication devices in idle mode in response to receipt of an idle mode entry response from the node of the first wireless communication network.

13. An apparatus as defined in claim 8 further comprising a controller to exit one or more of the plurality of wireless communication devices from idle mode in response to transmitting an idle mode exit request.

14. An apparatus as defined in claim 8 further comprising a controller to establish a wireless communication link between the second wireless communication device and a node of the second wireless communication network in response to transmitting an idle mode exit request.

15. An article of manufacture including content, which when accessed, causes a machine to:
generate an idle mode message having idle mode information associated with a plurality of wireless communication devices coexisting and located within a single platform at a subscriber station, the plurality of wireless communication devices having at least a first wireless communication device associated with a first wireless communication network and a second wireless communication device associated with a second wireless communication network; and
select the first wireless communication device to transmit the idle mode message to a first paging controller of the first wireless communication network via a node of the first wireless communication network, the first paging controller being operatively coupled to the node of the first wireless communication network and configured to forward the idle mode message to a second paging controller of the second wireless communication network.

16. An article of manufacture as defined in claim 15, wherein the content, when accessed, causes the machine to generate the idle mode message by generating at least one of an idle mode entry request or an idle mode exit request.

17. An article of manufacture as defined in claim 15, wherein the content, when accessed, causes the machine to transmit the idle mode message to at least one of an access point of a wireless local area network, a base station of a wireless metropolitan area network, or a base station of a wireless wide area network.

18. An article of manufacture as defined in claim 15, wherein the content, when accessed, causes the machine to receive an idle mode entry response having paging information for one or more of the plurality of wireless communication devices to enter into idle mode, the paging information having information associated with at least one of paging cycle or paging offset.

19. An article of manufacture as defined in claim 15, wherein the content, when accessed, causes the machine to operate one or more of the plurality of wireless communication devices in idle mode in response to receipt of an idle mode entry response from the node of the first wireless communication network.

20. An article of manufacture as defined in claim 15, wherein the content, when accessed, causes the machine to exit one or more of the plurality of wireless communication devices from idle mode in response to transmitting an idle mode exit request.

21. An article of manufacture as defined in claim 15, wherein the content, when accessed, causes the machine to establish a wireless communication link between the second wireless communication device and a node of the second wireless communication network in response to transmitting an idle mode exit request.

22. A system comprising:
an omni-directional antenna; and
a processor operatively coupled to the antenna to generate an idle mode message having idle mode information associated with a plurality of wireless communication devices including at least a first wireless communication device associated with a first wireless communication network and a second wireless communication device associated with a second wireless communication network, and to select the first wireless communication device to transmit the idle mode message to a first paging controller of the first wireless communication network via a node of the first wireless communication network,
wherein the first paging controller is operatively coupled to the node of the first wireless communication network and configured to forward the idle mode message to a second paging controller of the second wireless communication network, and
wherein the plurality of wireless communication devices coexist and are located within a single platform at a subscriber station.

23. A system as defined in claim 22, wherein the processor is configured to generate the idle mode message by generating at least one of an idle mode entry request or an idle mode exit request.

24. A system as defined in claim 22, wherein the processor is configured to transmit the idle mode message to at least one of an access point of a wireless local area network, a base station of a wireless metropolitan area network, or a base station of a wireless wide area network.

25. A system as defined in claim 22, wherein the processor is configured to receive an idle mode entry response having paging information for one or more of the plurality of wireless communication devices to enter into idle mode, the paging information having information associated with at least one of paging cycle or paging offset.

26. A system as defined in claim 22, wherein the processor is configured to operate one or more of the plurality of wireless communication devices in idle mode in response to receipt of an idle mode entry response from the node of the first wireless communication network.

27. A system as defined in claim 22, wherein the processor is configured to exit one or more of the plurality of wireless communication devices from idle mode in response to transmitting an idle mode exit request.

28. A system as defined in claim 22, wherein the processor is configured to establish a wireless communication link between the second wireless communication device and a node of the second wireless communication network in response to transmitting an idle mode exit request.

29. A method comprising:
receiving an idle mode message from a subscriber station at a first paging controller of a first a wireless communication network via a node of the first wireless communication network, the subscriber station having a platform with a plurality of wireless communication devices including at least a first wireless communication device associated with the first wireless communication network and a second wireless communication device associated with a second wireless communication network, and
transmitting the idle mode message to a second paging controller of the second wireless communication network,
wherein the idle mode message includes idle mode information associated with the plurality of wireless communication devices.

30. A method as defined in claim 29, wherein receiving the idle mode message comprising receiving at least one of an idle mode entry request or an idle mode exit request.

31. A method as defined in claim 29, wherein receiving the idle mode message comprising receiving the idle mode message from the subscriber station via an access point of a wireless local area network, a base station of a wireless metropolitan area network, or a base station of a wireless wide area network.

32. A method as defined in claim 29 further comprising receiving paging information for the second wireless communication device to enter into idle mode from the second paging controller.

33. A method as defined in claim 29 further comprising transmitting an idle mode entry response to the subscriber station via the node of the first wireless communication network, the idle mode entry response having paging information for the first and second wireless communication devices to enter into idle mode.

34. A method as defined in claim 29, wherein the first paging controller is integrated into the node of the first wireless communication network.
